(19) United States
(12) Patent Application Publication
(10) Pub. No.: US 2007/0044815 A1
(43) Pub. Date: Mar. 1, 2007

(54) SWIVEL FLOSSER SYSTEM

(76) Inventor: TAUHEED ASHRAF, Bolingbrook, IL (US)

Correspondence Address: TAUHEED ASHRAF, 2250 JANICE LANE, BOLINGBROOK, IL, 60490, US

(21) Appl. No.: 11/468,464

(22) Filed: Aug. 30, 2006

Related U.S. Application Data
(60) Provisional application No. 60/712,715, filed on Aug. 30, 2005.

(51) Int. Cl. A61C 15/00

(52) U.S. Cl. 132/323

(57) ABSTRACT

The Swivel Flosser comprises of these parts: a handle portion which is used to hold the flosser, a head portion which grasps the dental floss and has a u shaped configuration. The dental floss is part of the head portion. The head and the handle can be assembled by the user, once assembled together the head can rotate with respect to the handle allowing the user to clean the front teeth, the molars and everything in between with ease. The handle as well as the head can both be disposable or reusable according to utility and personal preference.

### CROSS-REFERENCE TO RELATED APPLICATIONS

The present application incorporates by reference in its entirety U.S Provisional Patent Application No. “60/712,715” filed “Aug. 30, 2005”, filed by “Tauheed Ashraf”, entitled “Swivel flosser, which allows to reach the back teeth with ease”.

### TECHNICAL FIELD

This particular design relates to advanced dental flossing. The Swivel flosser system allows it to be used as a replacement for a conventional flosser as it provides enhanced features for far reaching cleaning with facility.

### BACKGROUND OF THE INVENTION

Dental floss that came in strands and rolled up in a convenient package is commonly used to clean between teeth, however recently a disposable and reusable device called the “Flosser” has been used to achieve the same function of hygienically cleaning the teeth without having to manually hold the dental floss by both hands. Flossers can be used single handedly; the user can insert the flosser in their mouth at different angles in order to get in between all teeth. The issue in such a teeth cleaning device is that reaching the molars is sometimes problematical since the user has to keep their mouth wide open and gropingly insert the flosser in the mouth sideways. FIG. 1 depicts a generic flosser that is commonly used. The “Swivel Flosser System” was invented as the aforementioned products that are available in the market have manifold flaws. Most flossers of varying kinds are difficult to insert in the spaces between molars and the limited flexibility of said flossers lead to slippages during use. The innovation of the “Swivel Flosser System” is that it rotates and flexibly reaches all teeth. In this document this invention will be referred to as “Swivel Flosser System”, “Swivel Flosser”, “the Flosser”, “present invention”, and “preferred embodiment”.

### BRIEF SUMMARY OF THE INVENTION

According of one embodiment of the present invention, a swivel flosser allows the user to reach all teeth with ease. In the preferred embodiment as depicted in FIG. 2, the flosser consists of two pieces referred to respectively as head and handle, these two pieces are assembled together using built-in latching features as depicted in FIG. 8 and FIG. 11. Once fitted together these two pieces can rotate with respect to each other and allow the user to revolve the flosser head prior to inserting in the mouth. This feature creates an easy flow with which one can facilitate and shorten the duration of flossing.

### BRIEF DESCRIPTION OF THE SEVERAL VIEWS OF THE DRAWINGS

FIG. 1 is a depiction of a generic flosser.

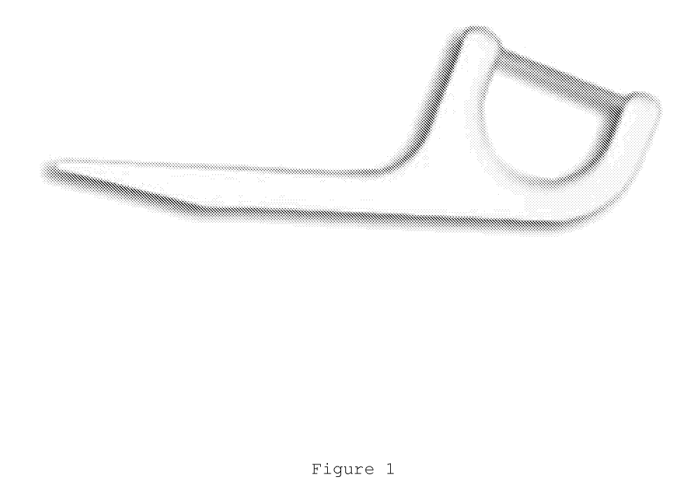

FIG. 2 is an angled view of the preferred embodiment, which shows the head at 90 degrees with respect to the handle.

FIG. 3 is an angled view of the preferred embodiment, which shows head inline with the handle.

FIG. 4 is an angled view of the preferred embodiment, which shows the head at 45 degrees with respect to the handle.

FIG. 5 is side view of the preferred embodiment.

FIG. 6 is bottom view of the preferred embodiment.

FIG. 7 is top view of the preferred embodiment.

FIG. 8 is an angled view of the head portion of the preferred embodiment.

FIG. 9 is front view of the head portion of the preferred embodiment.

FIG. 10 is bottom view of the head portion of the preferred embodiment.

FIG. 11 is an angled view of the handle portion of the preferred embodiment.

FIG. 12 is top view of the handle portion of the preferred embodiment.

FIG. 13 is bottom view of the handle portion of the preferred embodiment.

FIG. 14 is side view of the handle portion of the preferred embodiment.

FIG. 15 is another embodiment of the swivel flosser

FIG. 16 is the head portion of the embodiment shown in FIG. 15.

FIG. 17 is the handle portion of the embodiment shown in FIG. 15.

FIG. 18 is another embodiment of the swivel flosser.

FIG. 19 is the head portion of the embodiment shown in FIG. 18.

FIG. 20 is the handle portion of the embodiment shown in FIG. 18.

### DETAILED DESCRIPTION OF THE INVENTION

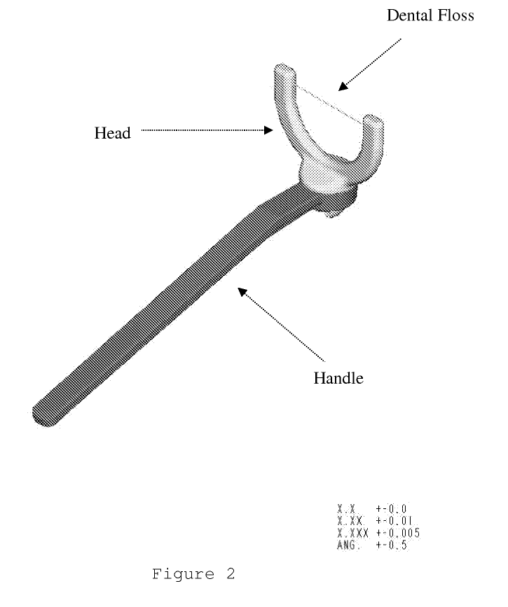

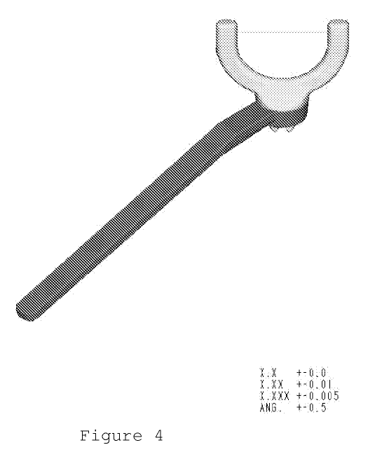

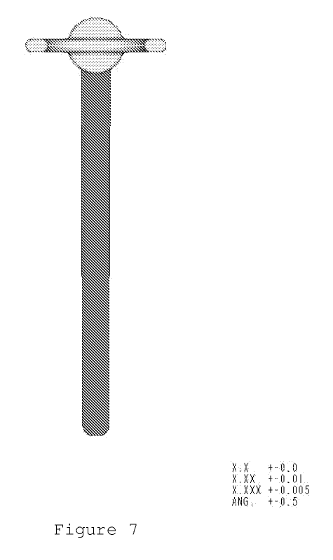

The present invention is directed to ease the use of flossers, and effectively clean all teeth. FIG. 2-7 shows various views of a preferred embodiment, in which the flosser consists of two parts labeled as the head and the handle. The head part is what houses the floss and the handle is used to control the manifold positions of the flosser. These two pieces have been designed to mechanically snap or latch together and create a swivel flosser. In the preferred embodiment the head can rotate with respect to the handle at any angle in increments of 45 degrees. Another feature in the preferred embodiment does not allow it to rotate freely or spin uncontrollably and this is a locking mechanism in the latching function which allows it to rotate only a certain degrees at a time. This feature is needed to allow the user of the “Swivel Flosser System” to rotate the head at a certain angle and keep it there for cleaning teeth at that particular angle.

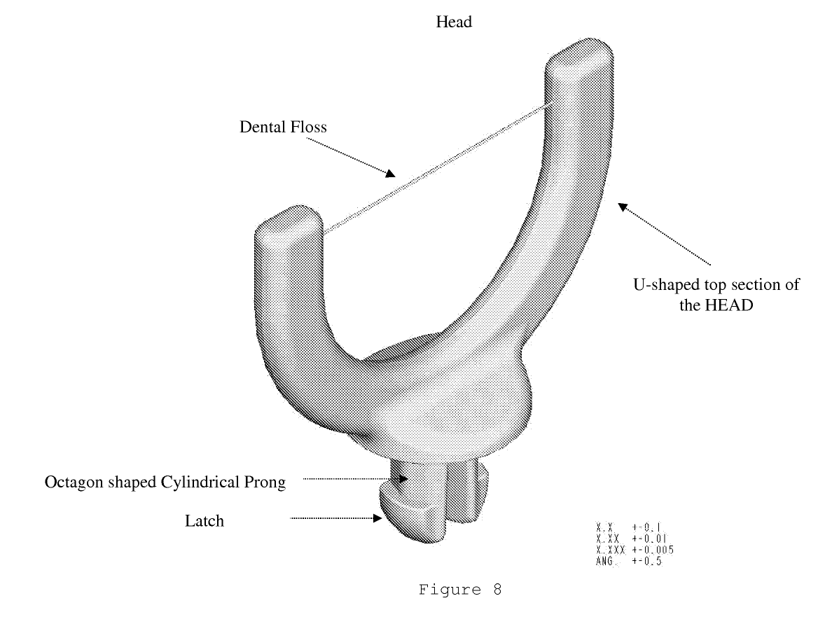

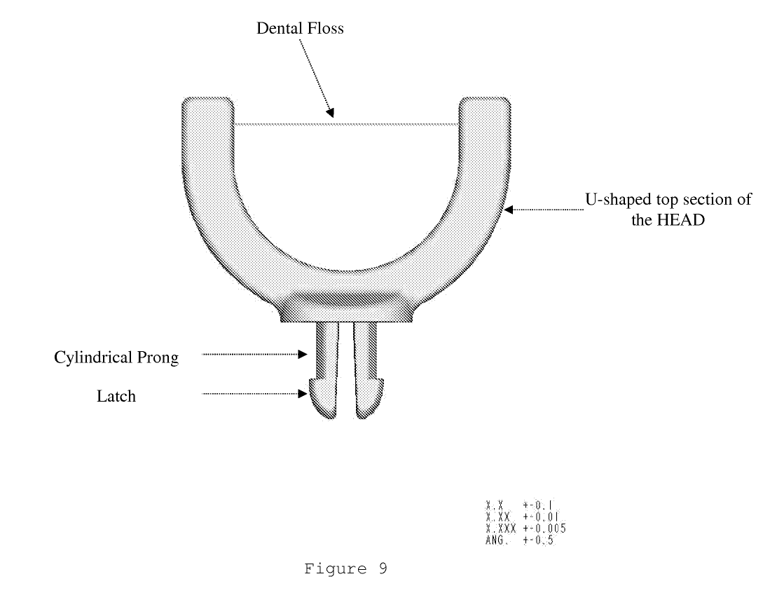

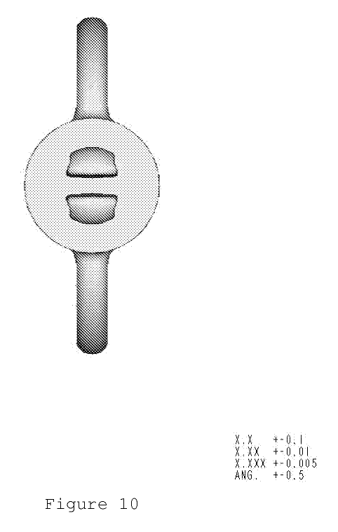

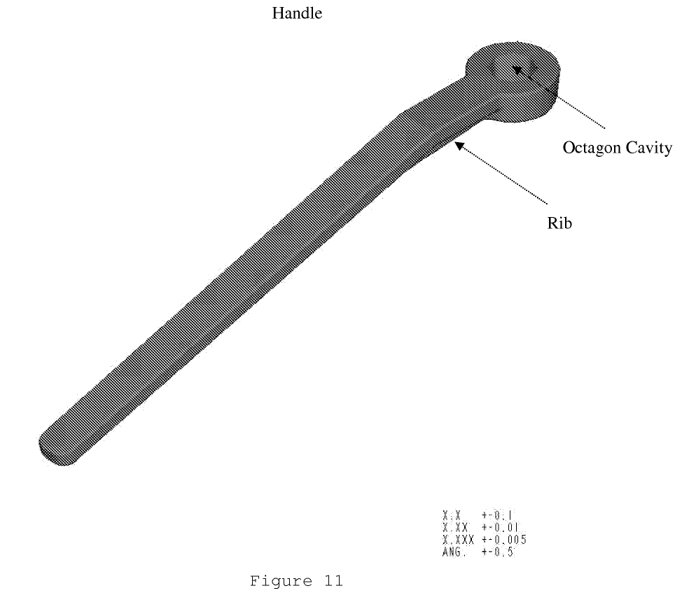

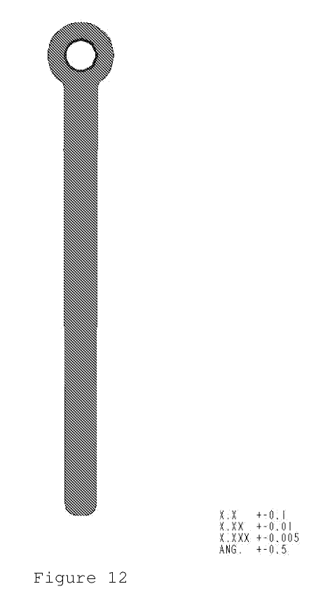

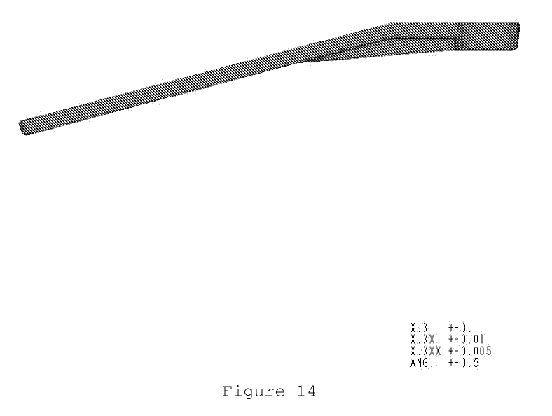

FIG. 8-14 shows the two pieces separately for the preferred embodiment shown in FIG. 2. These two pieces can be manufactured separately using injection plastic molding. The dental floss can be made part of the head portion by using over molding process. They can be easily assembled together by simply inserting the bottom end of the head portion which is depicted in FIG. 8 into the cavity of the handle which is depicted in FIG. 11. In the preferred embodiment the handle has a cavity in the shape of an octagon, the head section as depicted in the FIG. 8 consists of a U-shaped section which holds the dental floss and at the bottom of the U-shape there is a cylindrical area which consists of two prongs. The outside of the two prongs also have an octagon shape and it is made to correspond into the octagon cavity of the handle. Also at the bottom of the cylindrical shape of the head, there is a latch on each prong. When the cylindrical end of the head portion is inserted through the octagon cavity of the handle, the latches push the two prongs together and once the latches pass through the cavity the latches snap back into place thus holding the head and the handle firmly together. The head portion can be easily disassembled and detached from the handle portion by squeezing the two latches together and pushing them back into the cavity of the handle while simultaneously pulling the top end of the head portion. The head portion will pop out and then can be replaced by another disposable head if so desired. In the preferred embodiment depicted in FIG. 2, the handle portion is reusable whereas the head portion is disposable. However both portions can either be jettisoned or recycled.

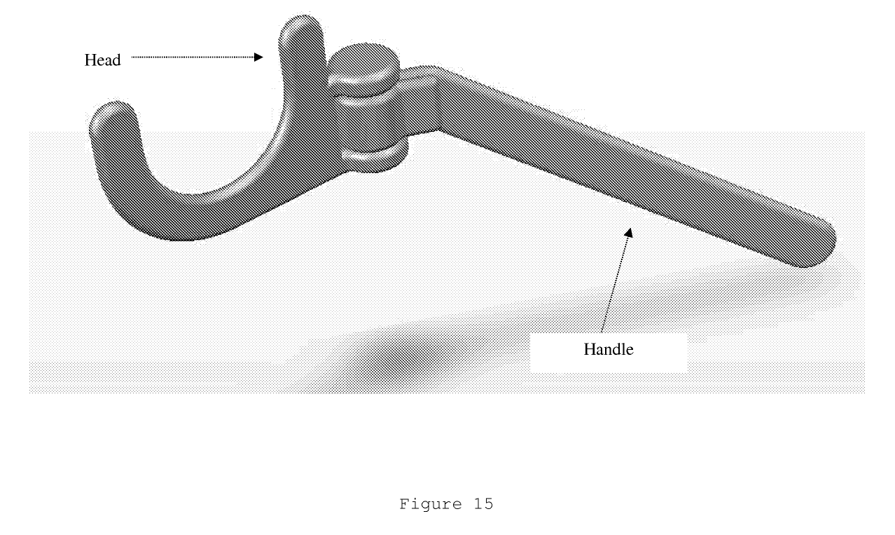

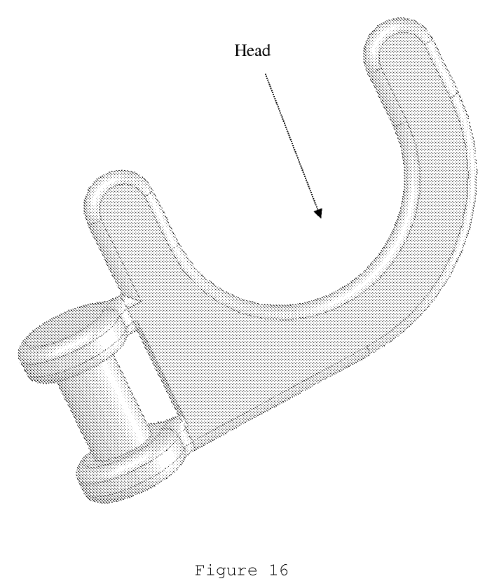

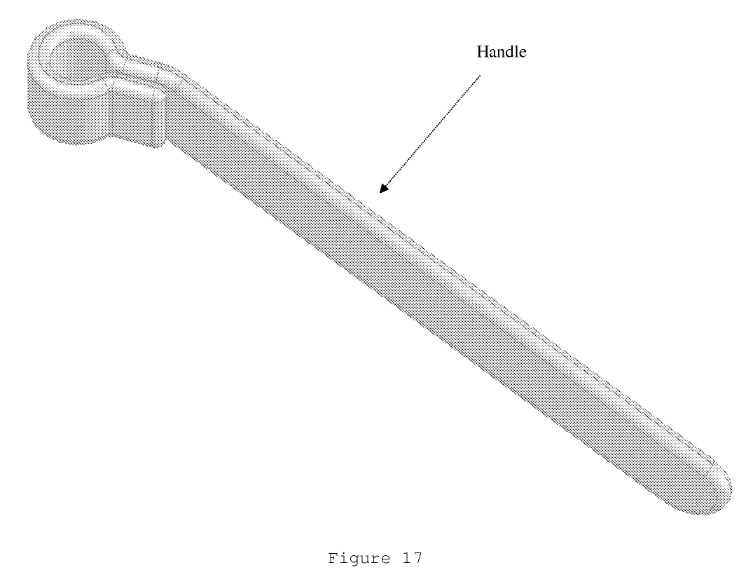

FIG. 15 shows another embodiment in which the head and the handle have slightly different locking and latching mechanisms. Again this embodiment is shown to provide yet another way of manufacturing this product. In this embodiment the hook end of the handle makes a loop around the cylindrical shaped end of the head. This mechanism is there to ensure that this part stays firmly together after it is assembled. This embodiment gives this part more strength at the joint. This embodiment consists of two separate pieces head and handle depicted in FIG. 16 and FIG. 17 respectively, similar to the preferred embodiment the two pieces will be manufactured separately and assembled together by snapping the loop end of the handle around the cylindrical end of the head. This feature will allow it to hold the two pieces together once they are assembled.

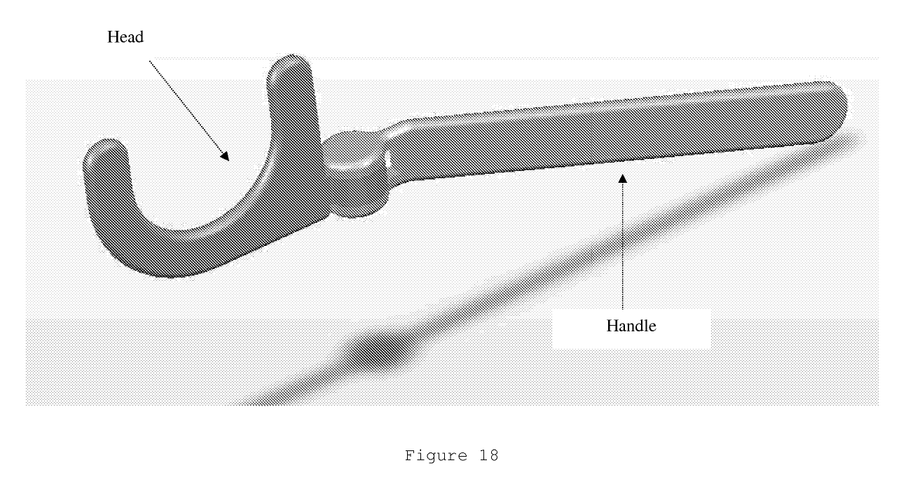

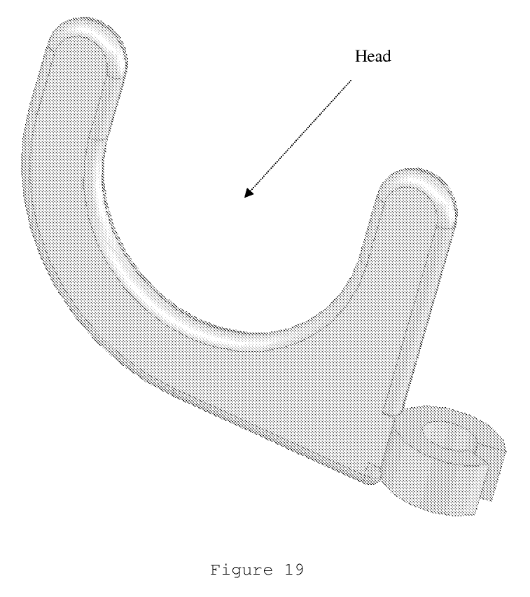

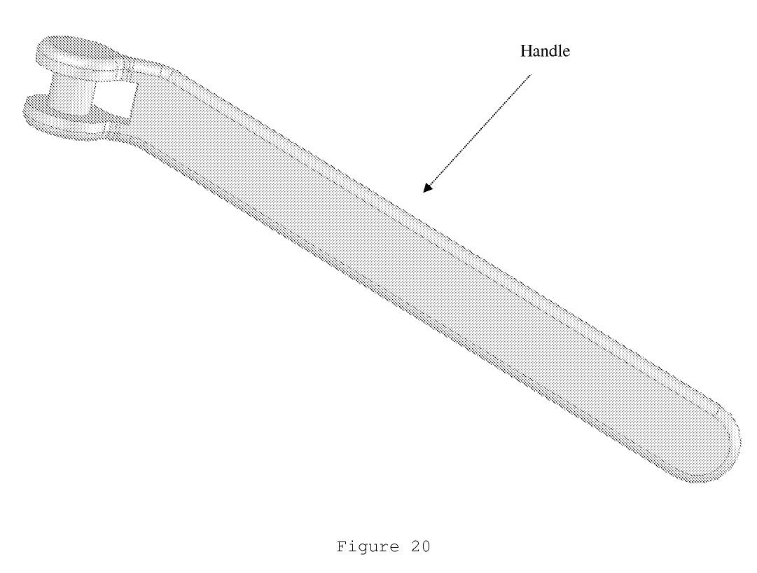

Another embodiment is depicted in FIG. 18 and its respective two separate pieces depicted in FIG. 19 and FIG. 20, similar to the preferred embodiment the two pieces will be manufactured separately and assembled together by snapping the C-shaped end of the handle around the cylindrical end of the head. This feature will allow it to hold the two pieces together once they are assembled.

The three embodiments shown in FIG. 2, FIG. 15, and FIG. 18 are three ways of designing the same concept behind the swivel flosser. Other designs encompassing the same concept can be done with relative ease.

1. The swivel flosser system comprises of these parts: a handle portion which is used to hold the flosser containing an interlocking latching mechanism, a head portion which holds the dental floss and has a construction that is U-shaped containing said latching mechanism, the head and the handle can be assembled by using the built-in latch features in both head and handle which allow the head to rotate with respect to the handle

2. The swivel flosser system according to claim 1 in which head and handle can be assembled by anyone who intends to assemble these parts without the use of any tools.

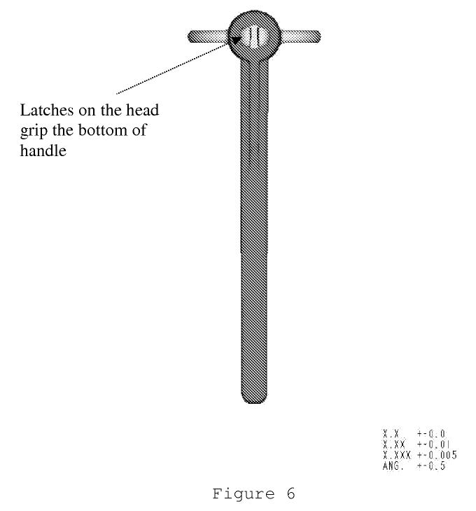

3. The swivel flosser system according to claim 1 can be assembled by inserting the latch end of the head into the cavity of the handle until the latches pass through the cavity and revert back into place, the latching features of the preferred embodiment are depicted in FIG. 6, FIG. 8, and FIG. 11.

4. The swivel flosser system according to claim 1 when assembled together comprises of a disposable head that can rotate with respect to the handle allowing the user to clean the front teeth, the molars and all other teeth in between with ease.

5. According to claim 1 both head and handle will be manufactured by plastic injection molding process.

6. According to claim 1 the dental floss stretches between the two extensions of the head, and will be made part of the head portion by utilizing over-molding process.

7. The swivel flosser system according to claim 1 wherein said handle and head pieces can be made disposable or reusable.

8. The swivel flosser system according to claim 1 wherein said two pieces are assembled (interlocked into place) the user will be able to rotate (swivel) the head with respect to the handle at various angles which the preferred embodiment shows in FIG. 2-7, the head portion can be rotated at 45 degree angles, in other embodiments shown in FIG. 15-20 the head portion can rotate with much less restriction.

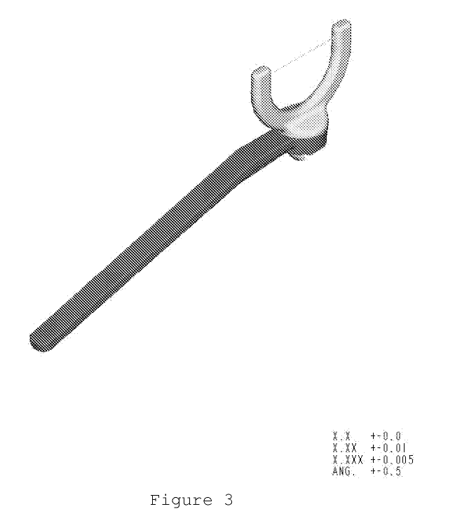

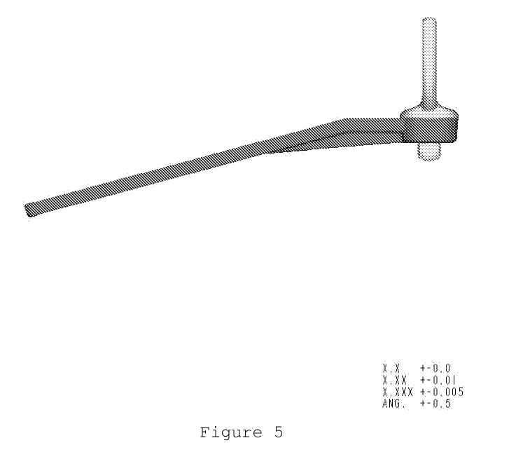

9. The swivel flosser system according to claim 1 wherein said the swivel or rotate function of the “Swivel Flosser System” allows it to be used easily for all teeth, when the head is inline with the handle as depicted in FIG. 3 the flosser can be used with ease for the front teeth, when the head is rotated 90 degrees as depicted in FIG. 2 and FIG. 5, the Swivel flosser can be used with ease for the back teeth, and any angle in between will allow it to be used for any teeth in between.

10. According to claim 1 in all its embodiments the head and the handle can be assembled or put together by a capable user.

11. According to claim 1 in its preferred embodiment the swivel flosser can be disassembled by a capable user.

12. According to claim 1 in all the preferred embodiments once the handle and head are assembled they will act as one piece that can be used by the user.

13. According to claim 1 the head portion has a U-shape base and the dental floss runs straight through one end of the U-shape to the other end.

14. According to claim 1 in the preferred embodiment as depicted in FIG. 2 once assembled together the prongs in the head section press against the cylindrical cavity of the handle portion which allows it to maintain its rotation.

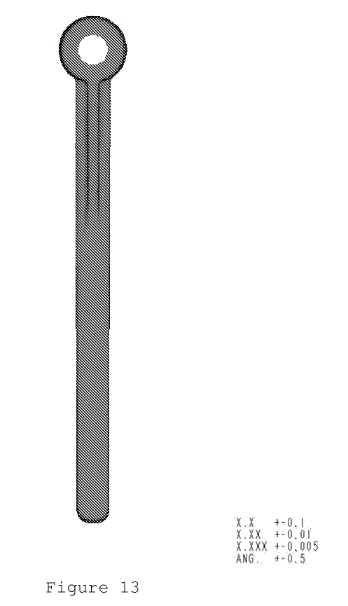

15. The handle portion in the preferred embodiment has a rib on the bottom side as depicted in FIG. 13 to provide added strength to the handle and the cavity provides latching mechanism.

16. According to claim 15 the opening in the handle portion as well as the cylindrical section for the head portion is octagon in shape, and the edges of the octagon are smoothened out to allow for easy rotation of the head with respect to the handle.

17. According to claim 15 the handle is made flat to provide firm grip so that it can be conveniently held by the user during activation.

18. The latches at the bottom of the head portion allow the head to firmly grip the handle portion during use by the user; these latches are depicted in FIG. 6 and they prevent the two pieces from coming apart during use.

19. According to claim 18 the latching features in the head portion are small enough to allow insertion into the mouth and to reach molars without irritating the user.

20. According to claim 18 in the preferred embodiment as depicted in FIG. 2 the latches in the head that allow said head to be held in place by pressing onto the bottom side of the handle.
